(19) United States
(12) Patent Application Publication
(10) Pub. No.: US 2015/0172479 A1
(43) Pub. Date: Jun. 18, 2015

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Jumpei Sano, Tokyo (JP)

(21) Appl. No.: 14/563,909

(22) Filed: Dec. 8, 2014

(30) Foreign Application Priority Data
Dec. 12, 2013 (JP) 2013-257163

(51) Int. Cl. H04N 1/00; G06Q 20/14; H04N 1/60

(52) U.S. Cl. CPC H04N 1/00161; H04N 1/0044; H04N 1/00143; H04N 1/00167; H04N 1/00188; H04N 1/60; G06Q 20/145; H04N 2201/0094

(57) ABSTRACT

An image processing apparatus includes a determination unit that determines whether each pixel included in a printing target input image is color, a display unit that displays, before printing of the input image, an image in which the pixel determined as color and the pixel not determined as color that are included in the input image are discriminable to a user, and a setting unit that sets a charge for the printing of the input image at one of charge candidates in three or more levels based on a number of the pixels determined as color that are included in the input image.

### BACKGROUND

1. Field

Aspects of the present invention generally relate to an image processing technique, and particularly relates to an image processing technique for discriminably displaying a region, which has been determined as a color region, in an image.

2. Description of the Related Art

As one type of charging systems for multifunction peripherals (MFPs), a charging system based on color usage has been conventionally known (for example, see Japanese Patent Application Laid-Open No. 2002-091743). In this type of charging system, during charging processing for color printing in an MFP, a charge for printing is selected according to a ratio of a color region in a printing target image from among at least three or more charge candidates, and the selected charge is set. This type of charging system has an advantage of being able to provide an easy-to-use and fair charging system to a user who carries out printing of an image including a small color region, as compared with a system that demands a charge for full-surface color printing even for a small color region.

However, in an image processing apparatus such as MFP adopting an existing charging system based on color usage, a user cannot see which part in an image is determined as a color region. Therefore, for a user who intends to carry out printing, it is difficult to understand a charge set based on usage.

### SUMMARY

According to an aspect of the present invention, an image processing apparatus includes, a determination unit configured to determine whether each pixel included in image data corresponding to a printing target image is color, a display unit configured to display, before printing of the printing target image, an image in which the pixel determined as color and the pixel not determined as color that are included in the image data are discriminable to a user, and a setting unit configured to set a charge for the printing of the printing target image at one of charge candidates in three or more levels by using a number of the pixels determined as color that are included in the image data.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration example of a multifunction peripheral according to a first exemplary embodiment.

FIG. 2 is a flowchart of copy processing according to the first exemplary embodiment.

FIGS. 3A, 3B, and 3C are diagrams each illustrating an example of a preview screen according to the first exemplary embodiment.

FIG. 4 is a flowchart of display processing for a preview screen according to the first exemplary embodiment.

### DESCRIPTION OF THE EMBODIMENTS

Various exemplary embodiments will be described in detail below with reference to the drawings.

### System Configuration

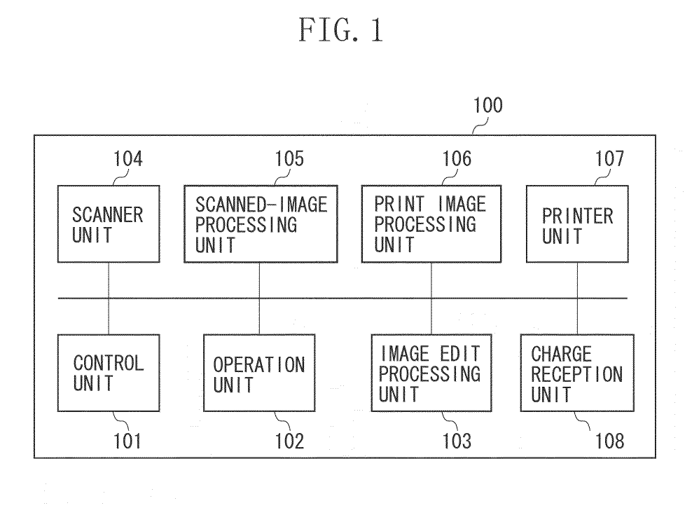

As an example of an exemplary embodiment of an image processing apparatus, a system configuration example of a multifunction peripheral (MFP) will be described with reference to FIG. 1. In a first exemplary embodiment, an MFP 100 that adopts a usage-based charging system will be described as an example. The MFP 100 performs printing and charges a user for the printing. The MFP 100 of the present exemplary embodiment includes a unit that receives money provided by the user as will be described below, but is not limited to the money. However, the payment method is not limited to money, and any other payment method, including one adopting a system using a prepaid card or one adopting a method based on an ID for identifying a user are applicable.

The MFP 100 includes a control unit 101, an operation unit 102, an image edit processing unit 103, a scanner unit 104, a scanned-image processing unit 105, a print image processing unit 106, a printer unit 107, and a charge reception unit 108.

The control unit 101 includes a central processing unit (CPU), a random access memory (RAM), a read only memory (ROM), and a hard disc drive (HDD). The CPU expands program data included in the ROM and the HDD into the RAM, and executes the program data.

The operation unit 102 includes hardware such as a liquid crystal display (LCD) touch screen, and serves as a user interface. A user sets copy information by operating this operation unit 102. The copy information includes information (color/monochrome instruction information) used by the control unit 101 to determine whether to perform copying by monochrome printing or copying by color printing. For example, the user sets the color/monochrome instruction information by instructing color printing or monochrome printing through the operation unit 102. Further, the copy information also includes information (preview instruction information) used by the control unit 101 to determine whether to display a preview of an image to be printed.

The image edit processing unit 103 reads image data stored in the control unit 101 (RAM), and performs image editing processing, such as resolution conversion processing, on the read image data. The image edit processing unit 103 then stores, in the control unit 101 (RAM), the image data on which the image editing processing has been performed.

The scanner unit 104 reads a document by using a sensor, and converts information of an image on the document into image data (which will be referred to as “document image data”) in a red-green-blue (RGB) color space. The scanner unit 104 then outputs the document image data to the scanned-image processing unit 105. In the present exemplary embodiment, the scanner unit 104 includes a charge-coupled device (CCD) sensor (not illustrated). The scanner unit 104 outputs the document image data by optically reading the image on the document.

The scanned-image processing unit 105 generates image data (scanned-image data) in the RGB color space by performing predetermined image processing, such as shading correction processing and misregistration correction processing, on the document image data input from the scanner unit 104. The scanned-image processing unit 105 then stores the scanned-image data in the control unit 101 (RAM).

The print image processing unit 106 reads the scanned-image data stored in the control unit 101 (RAM), and performs color conversion processing, which is to be determined based on color instruction information, on the read scanned-image data. The color conversion processing allows the print image processing unit 106 to generate image data (print image data) in a color space of cyan (C), magenta (M), yellow (Y), black (K) (CMYK) that are four process colors.

The color conversion processing converts a pixel value (an RGB value) in the RGB color space possessed by the print image processing unit 106 into a pixel value (a CMYK value) in the CMYK color space. It is to be noted that when the color/monochrome instruction information is “information indicating an instruction for copying by monochrome printing” (monochrome instruction information), the color conversion processing converts an RGB value of each pixel into a CMYK value in which only K color is significant. On the other hand, when the color/monochrome instruction information is “information indicating an instruction for copying by color printing” (color instruction information), the color conversion processing converts an RGB value of each pixel into a CMYK value in which at least one of four colors, CMYK is significant.

Further, the print image processing unit 106 performs halftone processing on the generated print image data, and outputs the print image data, on which the halftone processing has been performed, to the printer unit 107.

The printer unit 107 prints an image on a sheet by using color materials of the process colors based on the print image data input from the print image processing unit 106. In other words, the printer unit 107 prints a copy of the document.

The charge reception unit 108 has a money reception port and accepts a payment (receives money) from a user. In addition, the charge reception unit 108 determines an amount of money received from the user, and informs the control unit 101 of the determined amount. It is to be noted that when the amount is informed from the charge reception unit 108, the control unit 101 increases an amount counter stored in the RAM by the informed amount. An initial value of this amount counter is 0 (yen).

### Copy Processing

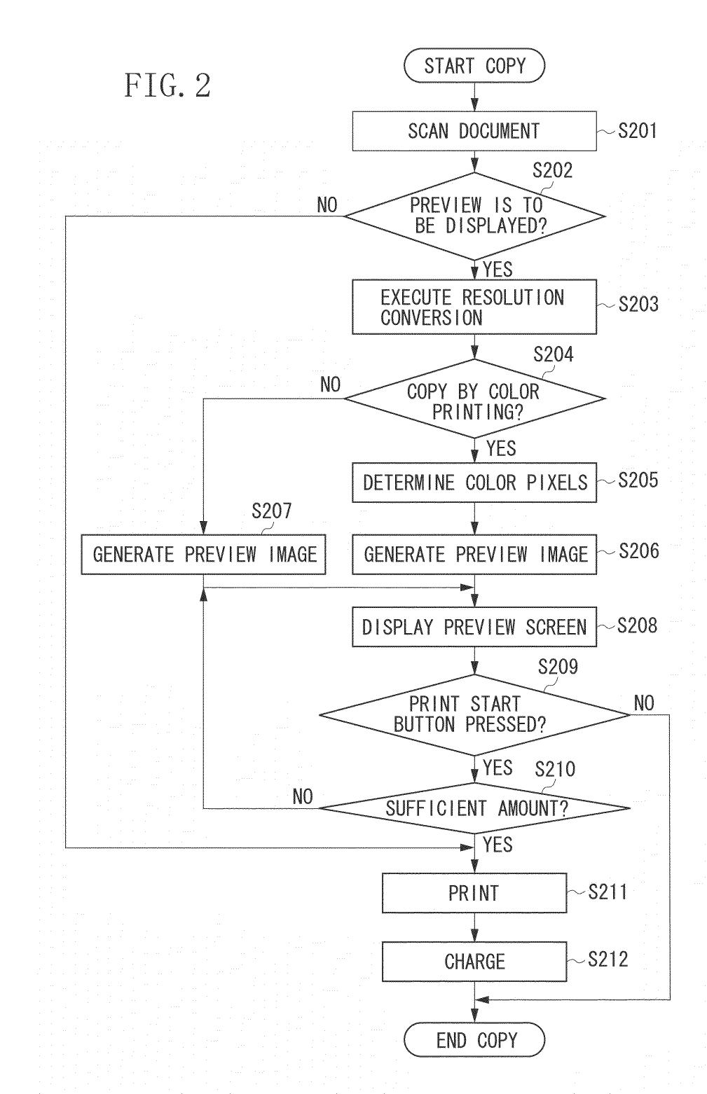

A flow of copy processing according to the present exemplary embodiment will be described with reference to a flowchart of FIG. 2. It is to be noted that a program for controlling this flow is stored in the HDD of the control unit 101. The CPU expands the program into the RAM and executes the program.

Before the copy processing, a user places a document to be copied on a document table of the scanner unit 104, and sets the copy information by operating the operation unit 102. The user then presses a copy start button of the operation unit 102. The flow of the copy processing starts when the control unit 101 detects the press of the copy start button. It is to be noted that upon start of the copy processing, the control unit 101 receives the copy information set by the operation unit 102.

In step S201, the scanner unit 104 scans the document. Specifically, the scanner unit 104 obtains document image data by reading the document placed on the document table, and outputs the obtained document image data to the scanned-image processing unit 105. The scanned-image processing unit 105 then generates scanned-image data from the input image data, and stores the generated scanned-image data in the control unit 101. The processing then proceeds to step S202.

In step S202, the control unit 101 determines whether to display a preview. Specifically, the control unit 101 determines whether the preview instruction information included in the copy information is “information indicating an instruction for displaying a preview of an image to be printed (preview ON information)”. When it is determined that the preview instruction information is the preview ON information (YES in step S202), the control unit 101 proceeds with the processing to step S203 to display a preview. On the other hand, when the control unit 101 determines that the preview instruction information is “information indicating an instruction for not displaying a preview of an image to be printed (preview OFF information)” (NO in step S202), the processing proceeds to step S211.

In step S203, the control unit 101 causes the image edit processing unit 103 to process the scanned-image data stored in step S201. The image edit processing unit 103 generates image data (preview resolution image data) of resolution of a preview image by performing the resolution conversion processing on the scanned-image data stored in the control unit 101. For example, the image edit processing unit 103 performs resolution conversion of the scanned-image data from 600 dpi (high definition) to 75 dpi (low resolution) that is suitable for display on the screen (the LCD touch screen) of the operation unit 102. The image edit processing unit 103 then stores the generated preview resolution image data in the control unit 101. The processing then proceeds to step S204.

In step S204, the control unit 101 determines whether to perform copying by monochrome printing or copying by color printing.

In this step S204, the control unit 101 determines whether the color/monochrome instruction information of the copy information is the color instruction information. When it is determined that the color/monochrome instruction information is the color instruction information (YES in step S204), the control unit 101 proceeds with the processing to step S205 to perform the copying by color printing. On the other hand, when the control unit 101 determines that the color/monochrome instruction information is the monochrome instruction information (NO in step S204), the processing proceeds to step S207.

It is to be noted that the determination in this step S204 may not be necessarily the processing performed using the color/monochrome instruction information set by the user instruction. For example, the determination in this step S204 may be performed using a known method called “Auto Color Select (ACS)”.

In step S205, the control unit 101 performs the following processing.

The control unit 101 determines, for each of pixels included in the preview resolution image data generated in step S203, whether the pixel is a color pixel or a monochrome pixel. A known method may be used for the processing for determining whether the pixel is a color pixel or a monochrome pixel (color determination processing). For example, for a pixel having an RGB value (r, g, b), the control unit 101 determines that the pixel is a monochrome pixel when a difference between a maximum and a minimum of the pixel value (r, g, b) is smaller than a predetermined threshold. Otherwise, the control unit 101 determines that the pixel is a color pixel. According to another method, the control unit 101 calculates color differences “u” and “v” in a Yuv color space from the RGB value (r, g, b), and determines that the pixel is a monochrome pixel when the color differences “u” and “v” are both smaller than predetermined thresholds. Otherwise, the control unit 101 determines that the pixel is a color pixel.

It is to be noted that the color determination processing of the present exemplary embodiment reflects the above-described color conversion processing performed by the print image processing unit 106. For example, assume that due to the color conversion processing performed by the print image processing unit 106, an RGB value (r, g, b) of a certain pixel included in the scanned-image data becomes a CMYK value (0, 0, 0, k) in which only K color is significant. In this case, the color determination processing of the present exemplary embodiment uses the above-described threshold provided to determine that a pixel of the preview resolution image data corresponding to the target pixel is a monochrome pixel. This is to prevent, in step S212 to be described below, a color charge from being made for the pixel printed with only a K color material.

Based on a result of the color determination processing for each of the pixels included in the preview resolution image data, the control unit 101 calculates the number of the color pixels and the ratio of the color pixels to all the pixels included in the preview resolution image data (i.e., a color region ratio C (%)). The processing then proceeds to step S206. This color region ratio C is used in copy charge setting processing in step S208 that will be described below.

In step S206, the control unit 101 generates color-region discrimination image data based on a result of the processing in step S205. The color-region discrimination image data is used for discriminably displaying a color region and a monochromatic region in the image as different regions to a user.

In this step S206, the control unit 101 generates color-region discrimination image data from the preview resolution image data by referring to the result of the processing in step S205. Specifically, the control unit 101 generates image data in the RGB color space as the color-region discrimination image data. In the image data in the RGB color space, the pixel value of the monochrome pixel included in the preview resolution image data remains unchanged, whereas the pixel value of the color pixel is replaced with a pixel value of a predetermined color. It is to be noted that this predetermined color in the present exemplary embodiment is a chromatic color (e.g., a chromatic color in which at least any one absolute value in each of the color differences “u” and “v” in the Yuv color space is equal to or greater than a predetermined value). For example, assume that yellow expressed by a fixed RGB value (255, 255, 0) is used as this predetermined color. In this case, the control unit 101 generates image data in which the pixel value of the monochrome pixel included in the preview resolution image data remains unchanged, whereas the pixel value of the color pixel is the RGB value (255, 255, 0).

It is to be noted that, in this step S206, the control unit 101 maintains the preview resolution image data as preview image data (color preview image data) of an image to be copied by color printing, without deleting the preview resolution image data. Upon completion of these processes for all the pixels, the processing proceeds to step S208.

On the other hand, in step S207, the control unit 101 generates preview image data (monochrome preview image data) of an image to be copied by monochrome printing.

In this step S207, first, the control unit 101 calculates brightness of each of the pixels included in the preview resolution image data generated in step S203. A known method may be used as a method for determining the brightness of the pixel. For example, the control unit 101 may calculate “g” in the RGB value included in the preview resolution image data (r, g, b), as the brightness of the pixel. Alternatively, the control unit 101 may calculate luminosity L in a Lab color space as the brightness of the pixel from the RGB value (r, g, b) of the pixel included in the preview resolution image data.

Further, the control unit 101 generates gray-scale image data as the monochrome preview image data. In the gray-scale image data, the pixel value of the pixel included in the preview resolution image data is replaced with a value representing the calculated brightness of the pixel. Upon completion of this process for all the pixels, the processing proceeds to step S208.

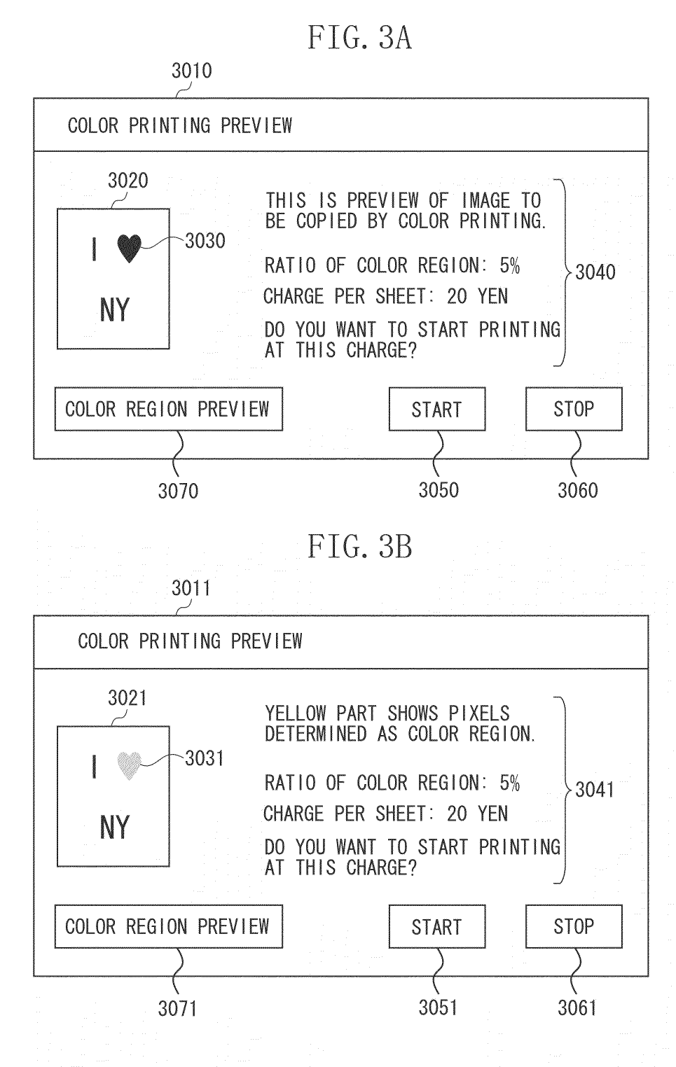

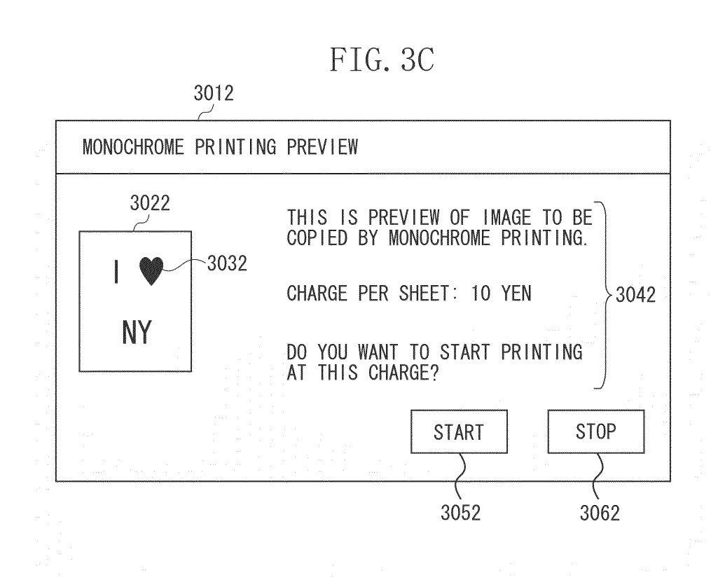

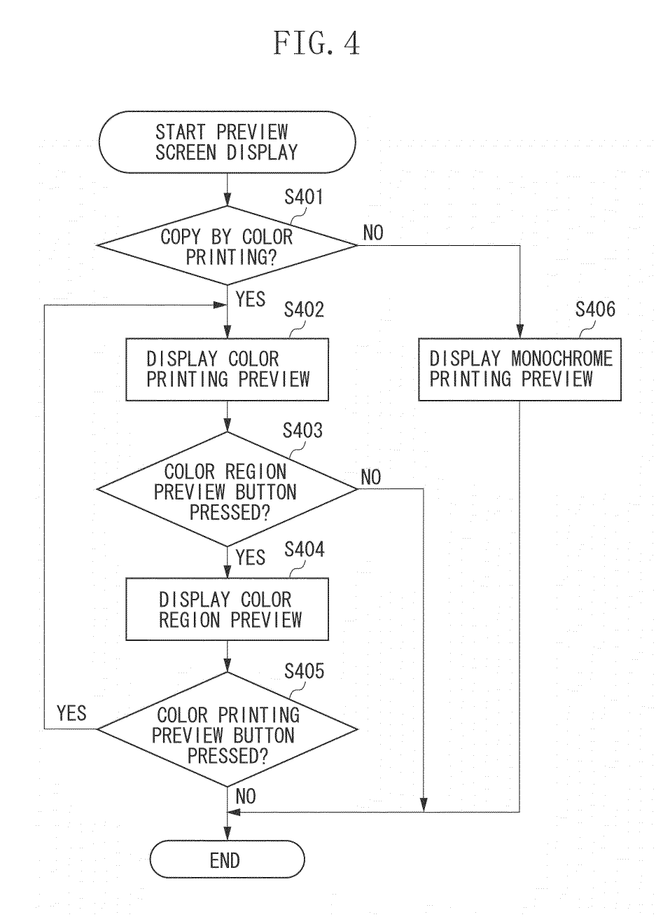

In step S208, the control unit 101 causes the operation unit 102 to display any one of the above-described color-region discrimination image data, color preview image data, and monochrome preview image data. Further, in this step S208, the control unit 101 sets a copy charge per document. The control unit 101 proceeds with the processing to step S209, upon detecting, through the operation unit 102, the press of a “print start button” or a “print stop button” displayed on the screen of the operation unit 102. It is to be noted that this step S208 will be described in more detail below, with reference to FIGS. 3A, 3B, 3C, and 4.

In step S209, the control unit 101 determines whether the button pressed by the user is the “print start button” or the “print stop button”. When the control unit 101 determines that “the print start button” has been pressed (YES in step S209), the processing proceeds to step S210. On the other hand, when the control unit 101 determines that the “print stop button” has been pressed (NO in step S209), the copy processing ends.

In step S210, the control unit 101 determines whether the amount counter stored in the RAM is equal to or higher than the copy charge set in step S208. When the amount counter is equal to or higher than the copy charge (YES in step S210), the amount of money received from the user is sufficient and therefore, the processing proceeds to step S211. When the amount counter is less than the copy charge (NO in step S210), the amount of money received from the user is not sufficient and therefore, the processing proceeds to step S208 in order to wait for the charge reception unit 108 to receive a sufficient amount of money from the user.

In step S211, the control unit 101 controls the print image processing unit 106 and the printer unit 107 so that a copy of the document is printed. The processing then proceeds to step S212.

In step S212, the control unit 101 performs charging processing for subtracting the copy charge set in step S208 from the amount counter stored in the RAM.

The copy processing is thus performed.

### Preview Display

Details of step S208 will be described with reference to FIGS. 3A, 3B, 3C, and 4.

FIG. 4 illustrates a detailed flow of step S208.

In step S401, the control unit 101 determines whether the color/monochrome instruction information is the color instruction information or the monochrome instruction information.

When the control unit 101 determines that the color/monochrome instruction information is the color instruction information (YES in step S401), the processing proceeds to step S402. When the control unit 101 determines that the color/monochrome instruction information is the monochrome instruction information (NO in step S401), the processing proceeds to step S406.

In step S402, the control unit 101 causes the operation unit 102 to display a “color printing preview screen 3010” illustrated in FIG. 3A. After causing the operation unit 102 to display the screen 3010, the control unit 101 waits until the control unit 101 detects, through the operation unit 102, the press of any one of a print start button 3050, a print stop button 3060, and a color region preview button 3070 by the user. Upon detecting the press of any one of these buttons, the control unit 101 proceeds with the processing to step S403.

Here, details of the display on the screen 3010 in step S402 will be described.

The screen 3010 is provided for the user to preview an image to be copied by color printing. The screen 3010 includes a preview image display region 3020, a charge display region 3040, the print start button 3050, the print stop button 3060, and the color region preview button 3070.

The above-described color preview image data is displayed in the preview image display region 3020. It is to be noted that a heart shape 3030 included in the displayed color preview image data is red like a heart shape in the image on the document.

What is displayed in the charge display region 3040 includes the color region ratio C calculated in step S205 and the copy charge per document set based on this color region ratio C. The control unit 101 sets the copy charge, based on the color region ratio C and a table of charges listed in the following Table 1.

TABLE 1

| Charge | Color Region | Copy Charge |
|---|---|---|
| Level | Ratio C (%) | Per Sheet |
| 1 | C = 0 | 10 yen |
| 2 | 0 < C ≦ 30 | 20 yen |
| 3 | 30 < C ≦ 60 | 40 yen |
| 4 | 60 < C ≦ 100 | 60 yen |

The table of charges listed in Table 1 is data stored beforehand in the HDD of the control unit 101. In the present exemplary embodiment, this table of charges defines candidates (charge candidates) in four levels for the copy charge. The copy charge setting processing using this table of charges will be described.

The control unit 101 determines which one of the “color region ratios C” in rows corresponding to charge levels 1 to 4 in the table of charges matches with the color region ratio C calculated in step S205. The control unit 101 then sets the copy charge per document at one of the charge candidates in the four levels, by referring to the “copy charge per sheet” in the row corresponding to the matched “color region ratio C”.

For example, assume that the color region ratio C calculated in step S205 is 0%. In other words, assume that the control unit 101 determines that copying is to be performed by color printing in step S204, and that the entire surface of the image is a monochrome region in step S205. In this case, the copy charge per document is set at 10 yen.

Alternatively, for example, when the color region ratio C is 5% as displayed in the charge display region 3040, the copy charge per document is set at 20 yen. For the other color region ratios C, the copy charge per document is similarly set.

The description will be continued returning to the flow.

In step S403, the control unit 101 determines which one of the three buttons 3050, 3060, and 3070 has been pressed by the user.

Specifically, when determining that the print start button 3050 or the print stop button 3060 has been pressed (NO in step S403), the control unit 101 ends this flow and proceeds with the processing to step S209 in FIG. 2.

On the other hand, the control unit 101 proceeds with the processing to step S404, when determining that the color region preview button 3070 has been pressed (YES in step S403).

In step S404, the control unit 101 causes the operation unit 102 to display a “color region preview screen 3011” illustrated in FIG. 3B. After causing the operation unit 102 to display the screen 3011, the control unit 101 waits until the control unit 101 detects, through the operation unit 102, the press of any one of a print start button 3051, a print stop button 3061, and a color printing preview button 3071 by the user. Upon detecting the press of any one of these buttons, the control unit 101 proceeds with the processing to step S405.

This screen 3011 is provided for the user to preview the region of the pixels determined as the color pixels in the color determination processing in step S205. The screen 3011 includes a preview image display region 3021, a charge display region 3041, the print start button 3051, the print stop button 3061, and the color printing preview button 3071.

The same contents as those in the charge display region 3040 are displayed in the charge display region 3041.

The above-described color-region discrimination image data is displayed in the preview image display region 3021. It is to be noted that a heart shape 3031 included in this displayed color-region discrimination image data is of the predetermined color (e.g., yellow having the RGB value (255, 255, 0)) used in the processing in step S206.

In this way, the color-region discrimination image data in which the color pixel is expressed by the predetermined color is displayed. Therefore, the user can understand a distribution region (the color region) of the color pixels used in the setting of the copy charge. As a result, the user can readily understand a basis of charging according to its level, behind the copy charge displayed in the charge display region 3041 (or the charge display region 3040).

The description will be continued returning to the flow.

In step S405, the control unit 101 determines, through the operation unit 102, which one of the three buttons 3051, 3061, and 3071 has been pressed by the user.

Specifically, when determining that the print start button 3051 or the print stop button 3061 has been pressed (NO in step S405), the control unit 101 ends this flow and proceeds with the processing to step S209 in FIG. 2.

On the other hand, when determining that the color printing preview button 3071 has been pressed (YES in step S405), the control unit 101 proceeds with the processing to step S402.

In step S406, the control unit 101 causes the operation unit 102 to display a “monochrome printing preview screen 3012” illustrated in FIG. 3C. Further, in this step S406, the control unit 101 sets the copy charge at a fixed charge of 10 yen, which is the copy charge for monochrome printing. After causing the operation unit 102 to display the screen 3012, the control unit 101 waits until the control unit 101 detects, through the operation unit 102, the press of either a print start button 3052 or a print stop button 3062 by the user. Upon detecting the press of either of these buttons, the control unit 101 ends this flow and proceeds with the processing to step S209 in FIG. 2.

Here, the screen 3012 in step S406 will be described.

This screen 3012 is provided for the user to preview an image to be copied by monochrome printing. The screen 3012 includes a preview image display region 3022, a charge display region 3042, the print start button 3052, and the print stop button 3062.

The above-described monochrome preview image data is displayed in the preview image display region 3022. It is to be noted that a heart shape 3032 included in the displayed monochrome preview image data is expressed by a gray scale as described with reference to step S207.

Since the copying is to be performed by monochrome printing, the above-described fixed charge of 10 yen for monochrome printing is displayed as the copy charge in the charge display region 3042.

This concludes the description of the detailed flow of the preview display performed in step S208.

According to the present exemplary embodiment, even when the copy charge is to be made according to its level, it is possible to display discriminably the distribution region, in the color image, of the color pixels used for setting the copy charge. This distribution region can be displayed to the user as a region different from the region forming the monochrome pixels, before the printing. Therefore, the user can readily understand a basis of charging according to its level.

In the color-region discrimination image data generated in step S206 of the first exemplary embodiment, the pixel value of the color pixel in the preview resolution image data is replaced with the predetermined pixel value. However, a target pixel value may be, instead of being the predetermined pixel value, a pixel value of a predetermined color set based on a tone (luminosity) of an original color pixel. For example, assume that the predetermined color is yellow having the RGB value (255, 255, 0). In this case, the pixel value of a yellow pixel, whose luminosity is higher as the luminosity of the original color pixel is higher, may be used as the target pixel value.

In addition, in the color-region discrimination image data generated in step S206 of the first exemplary embodiment, the pixel value of a monochrome pixel in the preview resolution image data remains unchanged without being replaced. However, the color-region discrimination image data may be such data that the pixel value of the monochrome pixel in the preview resolution image data is replaced with a predetermined pixel value different from the target pixel value of the color pixel. In this case, the target pixel value of the color pixel and the target pixel value of the monochrome pixel may only be substantially discriminable (with the user's eyes) to the user. For example, yellow having the RGB value (255, 255, 0) and blue having the RGB value (0, 0, 255) may be used.

In other words, in generation of the color-region discrimination image data, at least the pixel value of either the color pixel or the monochrome pixel included in the preview resolution image data may only be replaced with the predetermined pixel value that allows discrimination between the color pixel and the monochrome pixel.

It is to be noted that the following Table 2 enumerates the pixel values in the color-region discrimination image data that are considered to be substantially useful in practical use.

TABLE 2

| | Pixel Value | Pixel Value |
|---|---|---|
| Combination | Replacing Color | Replacing Monochrome |
| No. | Determination Pixel | Determination Pixel |
| 1 | Predetermined | Pixel value in |
| | pixel value | original image |
| 2 | First predetermined | Second predetermined |
| | pixel value | pixel value |
| 3 | Pixel value of | Pixel value in |
| | predetermined color | original image |
| | based on tone of | |
| | original pixel | |
| 4 | Pixel value in | Predetermined |
| | original image | pixel value |

A first combination in Table 2 is the combination used in the first exemplary embodiment.

In a second combination, the pixel value of the color pixel is replaced with a predetermined pixel value (a first predetermined pixel value) in a manner similar to that in the first exemplary embodiment. The pixel value of the monochrome pixel is replaced with a second predetermined pixel value that is different from the target pixel value of the color pixel.

The second combination can achieve shaper contrast between the color region and the monochromatic region in the color-region discrimination image data. However, there is no information indicating the pixel value of each pixel in the preview resolution image data. Therefore, it is difficult for a user to recognize that a pixel having what pixel value is a boundary for determining discrimination between the color pixel and the monochrome pixel.

In a third combination, the pixel value of the color pixel is replaced with a pixel value of a predetermined color (e.g., a predetermined hue) reflecting the tone of the pixel value of the color pixel. The pixel value of the monochrome pixel remains unchanged without being replaced with other pixel value.

In the third combination, unlike the first and second combinations in which the color region is solidly colored with the predetermined color, the color region reflects the tone of the original pixel value of the color pixel, in the color-region discrimination image data. Therefore, an obtained image is closer to the image of the document. However, when the original pixel value of the color pixel indicates extreme brightness or darkness, such a pixel value of the color pixel is replaced with a pixel value of a pixel that is hard to be discriminated from white or black. This may result in difficult discrimination between the color pixel and the monochrome pixel.

In a fourth combination, the pixel value of the color pixel remains unchanged without being replaced with a different pixel value, whereas the pixel value of the monochrome pixel is replaced with a predetermined pixel value.

The fourth combination can provide an effect of displaying only the color region in the color-region discrimination image data, by, for example, replacing the monochrome pixel with a background color of a preview image, such as white and black. However, when there is a color pixel of a color close to the background color, it may be difficult to be discriminated between such a color pixel and the monochrome pixel.

These are modifications of the present exemplary embodiment. As described above with reference to the modifications, the color-region discrimination image data generated in step S206 may be data in which the pixel value of the color pixel included in the preview resolution image data is replaced with a different pixel value. Alternatively, the color-region discrimination image data generated in step S206 may be data in which the pixel value of the monochrome pixel is replaced with a different pixel value. Further, the target pixel value may be the predetermined pixel value, or may be the pixel value reflecting the tone of the original pixel value. What is important is that the control unit 101 generates the color-region discrimination image data in which at least either the color pixel or the monochrome pixel is replaced with a different pixel value, so that the user can discriminate (with the user's eyes) between the color pixel and the monochrome pixel. The user may only need to easily understand the distribution region of the color pixels in the image that are related to the setting of the copy charge, by viewing the color-region discrimination image data displayed as a preview on the operation unit 102 before printing of the image.

In the above-described exemplary embodiment and modifications, the processing in each of steps S205, S206, S207, and S208 is performed on the preview resolution image data. Therefore, each processing can be completed faster than that in a case of using high-resolution scanned-image data. However, such processing may be performed on the high-resolution scanned-image data. In this case, the resolution conversion processing in step S203 of FIG. 2 may be performed when the operation unit 102 displays the preview resolution image data in step S208. Although a processing speed decreases, it is possible to perform the color determination processing in step S205 and the copy charge setting processing in step S208 with accuracy.

Further, in the above-described exemplary embodiment and modifications, the control unit 101 performs the control as follows. The control unit 101 determines whether the amount of money provided by the user is equal to or higher than the copy charge in step S210 before the print processing in step S211, and performs the print processing in step S211 based on a result of such determination. In another exemplary embodiment, the determination processing in step S210 may be omitted. In this case, upon completion of the print processing in step S211, the control unit 101 may store the copy charge in the RAM by adding this copy charge to an expected billing amount in the charging processing in step S212. In this case, a service provider of the copy processing may charge the user the expected billing amount, which is the sum of the copy charges, later such as at the end of a month.

Furthermore, in the above-described exemplary embodiment and modifications, the MFP is taken as an example of the image processing apparatus, but a single function printer (SFP) that performs printing based on color image data may be employed as an example of the image processing apparatus. In this case, the above-described determination as to whether image data input to the SFP is a color pixel or a monochrome pixel may be performed. Then, a preview image reflecting a result of such determination is caused to be displayed on a display connected to the SFP. It is to be noted that this display may be connected through a network or built in the SFP.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-257163 filed Dec. 12, 2013, which is hereby incorporated by reference herein in its entirety.

What is claimed is:

1. An image processing apparatus comprising:
a determination unit configured to determine whether each pixel included in image data corresponding to a printing target image is color;
a display unit configured to display, before printing of the printing target image, an image in which the pixel determined as color and the pixel not determined as color that are included in the image data are discriminable to a user; and
a setting unit configured to set a charge for the printing of the printing target image at one of charge candidates in three or more levels by using a number of the pixels determined as color that are included in the image data.

2. The image processing apparatus according to claim 1, wherein the display unit includes a generation unit configured to generate, as the image including the discriminable pixels, an image in which a pixel value of the pixel determined as color is replaced with a predetermined pixel value, whereas a pixel value of the pixel not determined as color remains unchanged.

3. The image processing apparatus according to claim 1, wherein the display unit includes a generation unit configured to generate, as the image including the discriminable pixels, an image in which a pixel value of the pixel determined as color is replaced with a first predetermined pixel value, whereas a pixel value of the pixel not determined as color is replaced with a second predetermined pixel value different from the first predetermined pixel value.

4. The image processing apparatus according to claim 1, wherein the display unit includes a generation unit configured to generate, as the image including the discriminable pixels, an image in which a pixel value of the pixel determined as color is replaced with a pixel value having a predetermined hue determined based on a tone of the pixel value to be replaced, whereas a pixel value of the pixel not determined as color remains unchanged.

5. The image processing apparatus according to claim 1, wherein the display unit includes a generation unit configured to generate, as the image including the discriminable pixels, an image in which a pixel value of the pixel determined as color remains unchanged, whereas a pixel value of the pixel not determined as color is replaced with a predetermined pixel value.

6. The image processing apparatus according to claim 1, wherein the determination unit obtains the image data by reducing resolution of the printing target image, and determines whether the pixel included in the obtained image data is color.

7. The image processing apparatus according to claim 1, further comprising a storage unit configured to store the charge set by the setting unit for charging the user after printing of the printing target image.

8. The image processing apparatus according to claim 1, further comprising:
a reception unit configured to receive an amount of money from the user; and
a control unit configured to perform control for allowing the printing of the printing target image when the amount of money received from the user is greater than or equal to the charge set by the setting unit.

9. The image processing apparatus according to claim 1, wherein the setting unit determines a ratio of the pixels determined as color by the determination unit and included in the image data to all pixels included in the image data, and sets the charge, based on the ratio, for the printing of the printing target image at one of the charge candidates in the three or more levels.

10. The image processing apparatus according to claim 1, further comprising a reading unit configured to obtain the printing target image by reading a document.

11. The image processing apparatus according to claim 1, further comprising a printing unit configured to print the printing target image.

12. An image processing method comprising:
determining whether each pixel included in image data corresponding to a printing target image is color;
displaying, before printing of the printing target image, an image in which the pixel determined as color and the pixel not determined as color by the determining that are included in the image data are discriminable to a user; and
setting a charge for the printing of the printing target image at one of charge candidates in three or more levels by using a number of the pixels determined as color that are included in the image data.

13. A non-transitory computer readable medium storing computer executable instructions for causing a computer to execute an image processing method, the image processing method comprising:
determining whether each pixel included in image data corresponding to a printing target image is color;
displaying, before printing of the printing target image, an image in which the pixel determined as color and the pixel not determined as color by the determining that are included in the image data are discriminable to a user; and
setting a charge for the printing of the printing target image at one of charge candidates in three or more levels by using a number of the pixels determined as color that are included in the image data.
